(19) United States
(12) Patent Application Publication
(10) Pub. No.: US 2024/0101300 A1
(43) Pub. Date: Mar. 28, 2024

(54) FIBERGLASS GROUND SLEEVE WITH CORNER REINFORCEMENT

(71) Applicant: Jeffrey Libbesmeier, Minnetonka, MN (US)

(72) Inventor: Jeffrey Libbesmeier, Minnetonka, MN (US)

(21) Appl. No.: 18/475,500

(22) Filed: Sep. 27, 2023

Related U.S. Application Data
(60) Provisional application No. 63/377,272, filed on Sep. 27, 2022.

(51) Int. Cl. B65D 1/46; B65D 81/02

(52) U.S. Cl. CPC B65D 1/46; B65D 81/02

(57) ABSTRACT

A ground sleeve or box pad having fiberglass corners includes metal reinforcements embedded within the corners in order to make the fiberglass corners resistant to damage by impact such as by lawnmowers and the like.

### PRIORITY STATEMENT

This application claims priority to Provisional Patent Application Ser. No. 63/377,272, filed Sep. 27, 2022 by Jeffrey Libbesmeier of Minnetonka, MN, entitled Fiberglass Ground Sleeve Corner Reinforcement, the contents of which are incorporated by reference herein in its entirety.

### BACKGROUND OF THE INVENTION

Ground sleeves and box pads are used to connect devices to underground cable ways and also to create a space for excess cables. Additionally, box pads provide a flat level surface on which to mount electrical devices, such as transformers. Because ground is rarely level, and in order to better protect the supported device, these sleeves and pads are typically buried such that a portion of the top is exposed above ground. Ground sleeves and pads are often constructed from fiberglass because fiberglass is relatively inexpensive, can be formed into any shape, is electrically insulative, weather resistant, and can be produced in any desired color. Green is often used when installed on a lawn in order to make the box less conspicuous.

One characteristic of fiberglass is that it tends to chip rather than bend or dent. This can be disadvantageous when located in an area, such as a lawn, where it may be impacted by equipment such as lawnmowers or trimmers. Especially susceptible to chipping are the corners of the sleeves. Eventually, chipped corners lead to a breach of the sleeve, allowing water to enter the enclosure. Further damage to the sleeve can eventually expose the electronics contained within the sleeve to damage from the elements, or allow animals or people to become endangered by high voltage electricity.

Giving the strength and resistance to chipping, metals such as steel or aluminum are more resistant to chipping than fiberglass. However, exposing relatively inexpensive metals such as these to the elements results in oxidation. As such, there is a clear need for a fiberglass ground sleeve that is resistant to both chipping and oxidation.

### OBJECTS AND SUMMARY OF THE INVENTION

The present invention pertains to various embodiments of a pad or ground sleeve that address the aforementioned needs. Generally, the embodiments include a fiberglass body with embedded corner reinforcements. These corner reinforcements, in some embodiments, are formed from a material such as aluminum or steel and are integrated into the fiberglass body during manufacturing such that the fiberglass body completely encompasses the reinforcements.

One aspect of the invention pertains to a ground sleeve comprising: a top surface; four walls including a front wall, a rear wall, a left side wall and a right side wall extending downwardly from the top surface, each wall having an outside surface and an inside surface; top corners formed at intersections between adjacent walls and the top surface; and, reinforcements located at each of the top corners; wherein the top surface and four walls are formed of a plastic; wherein the reinforcements are formed of a metal; and, wherein the reinforcements are embedded within the walls during formation of the walls between the outside surface the inside surface

In at least one embodiment the ground sleeve is fiberglass.

In at least one embodiment the reinforcement is a rectangular length of metal that is bent to form two sides angled to match the corner walls of the ground sleeve.

In at least one embodiment the reinforcement has three sides angled to match the corner walls and top surface of the ground sleeve.

Another aspect of the invention pertains to a ground sleeve having a body shaped to form a hollow box having a top surface and four walls extending downwardly; corners located at intersections of the walls and the top surface; and metal reinforcements embedded in each of the corners such that the reinforcements are completely encased by a material used to form the body.

Yet another aspect of the invention provides a ground sleeve that has a box-shaped body of a first material having four top corners, each of the four top corners having reinforcements of a second material embedded within walls of the body. The first material in some embodiments may be a plastic, such as fiberglass. The second material in some embodiments may be a metal, such as aluminum.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 is a perspective view of an example of a ground sleeve that may incorporate the corner reinforcement of the invention;

FIG. 2 is a front elevation of an example of an installed ground sleeve buried in the ground to illustrate the need for the present invention;

FIG. 3 is a front view of a corner of a ground sleeve having an embodiment of reinforcement of the invention embedded in the ground sleeve;

FIG. 4 is a left side view of a corner of a ground sleeve having an embodiment of reinforcement of the invention embedded in the ground sleeve;

FIG. 5 is a top plan view of a corner of a ground sleeve having an embodiment of reinforcement of the invention embedded in the ground sleeve;

FIG. 6 is a perspective view of a corner of a ground sleeve having an embodiment of reinforcement of the invention embedded in the ground sleeve, which has been embedded in the ground;

FIG. 7 is a top plan view of an embodiment of a corner reinforcement in an unfolded state;

FIG. 8 is a perspective view of the embodiment of the corner reinforcement of FIG. 7 in a folded state; and,

FIG. 9 is a perspective view of the embodiment of the corner reinforcement of FIG. 8 embedded in a corner of a ground sleeve, which has been embedded in the ground.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

Ground sleeves and pads are very similar and the terms “ground sleeve” and “pad” are often used interchangeably. In most instances, both ground sleeves and pads are rectangular structures that are formed of fiberglass and have corners that are vulnerable to damage by implements such as lawn mowers. The present invention addresses the identical problem faced by both pads and ground sleeves using the same solution. As such, for purposes of brevity, both pads and ground sleeves will hereinafter be referred to as “ground sleeves.”

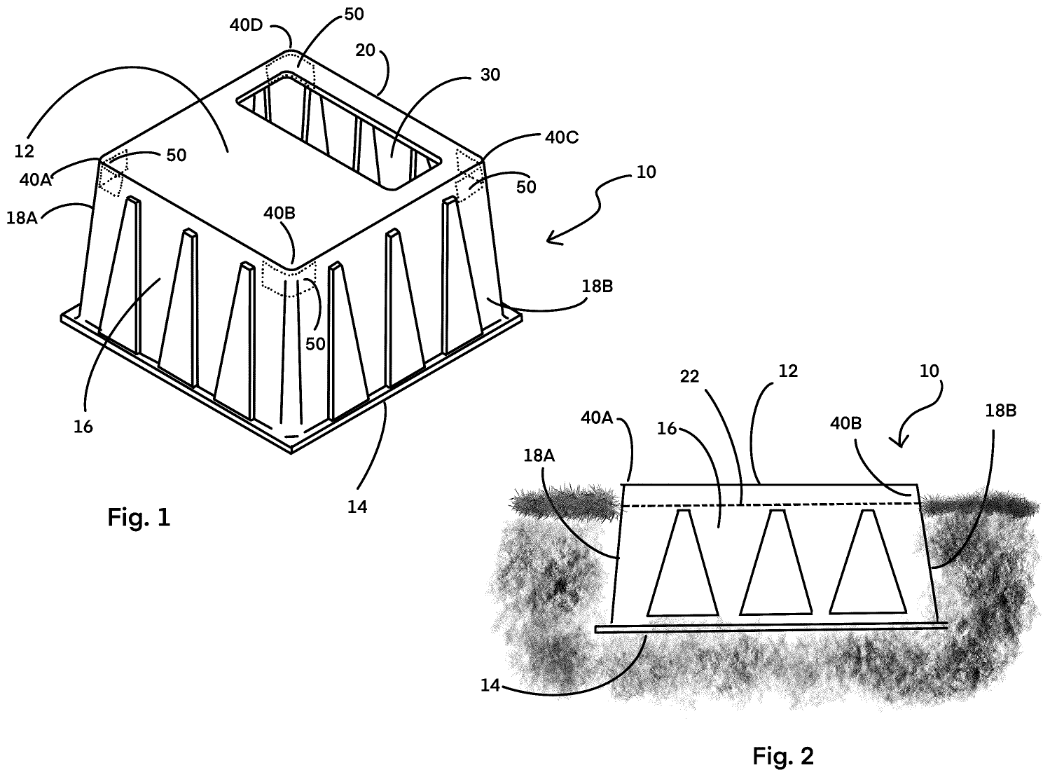

Turning now to the figures, FIG. 1 shows an embodiment of a typical ground sleeve 10 suitable for construction with the reinforcement 50 of the invention embedded in the corners. The ground sleeve 10 is a hollow fiberglass box having a top surface 12, a bottom perimeter 14, a front wall 16, a left side wall 18A, a right side wall 18B, and a rear wall 20. The top defines an opening 30 that allows access to the interior space of the ground sleeve 10 such that cables access the device to be mounted on the ground sleeve 10 have passage.

The ground sleeve 10 also has four top corners, 40A, 40B, 40C, and 40D. For purposes of this description, the terms “front,” “back,” left side,” and “right side,” are provided for aid in interpreting the figures and are not to be interpreted as having any other significance as the ground sleeve 10 may be installed in any orientation that suits the need. Similarly, the four top corners 40A, 40B, 40C, and 40D are distinguished from each other using letters A-D only to aid in understanding the figures. The corners are essentially identical in their incorporation of the invention.

The top corners 40A, 40B, 40C, and 40D are each shown as having a reinforcement 50 installed therein. The reinforcement 50 is placed in the corners during the construction of the ground sleeve 10 and placed between layers of fiberglass such that the reinforcement 50 is completely embedded within the fiberglass.

The problem being address is best understood looking at FIG. 2, which depicts a ground sleeve 10 having been installed in the ground according to known practices. When properly installed, the ground sleeve 10 is completely buried except for the top surface 12 and relatively small upper portions of the front wall 16, side walls 18A and 18B, and rear wall 20. The four top corners 40A, 40B, 40C, and 40D are also exposed. Dotted line 22 represents ground level and indicates that all portions above the dotted line 22 are vulnerable to damaging impacts by lawn equipment and the like. Of the exposed surfaces above the dotted line 22, the corners are significantly more prone to suffering damage than the surfaces between the corners. As such, the present invention is directed toward protecting these corners.

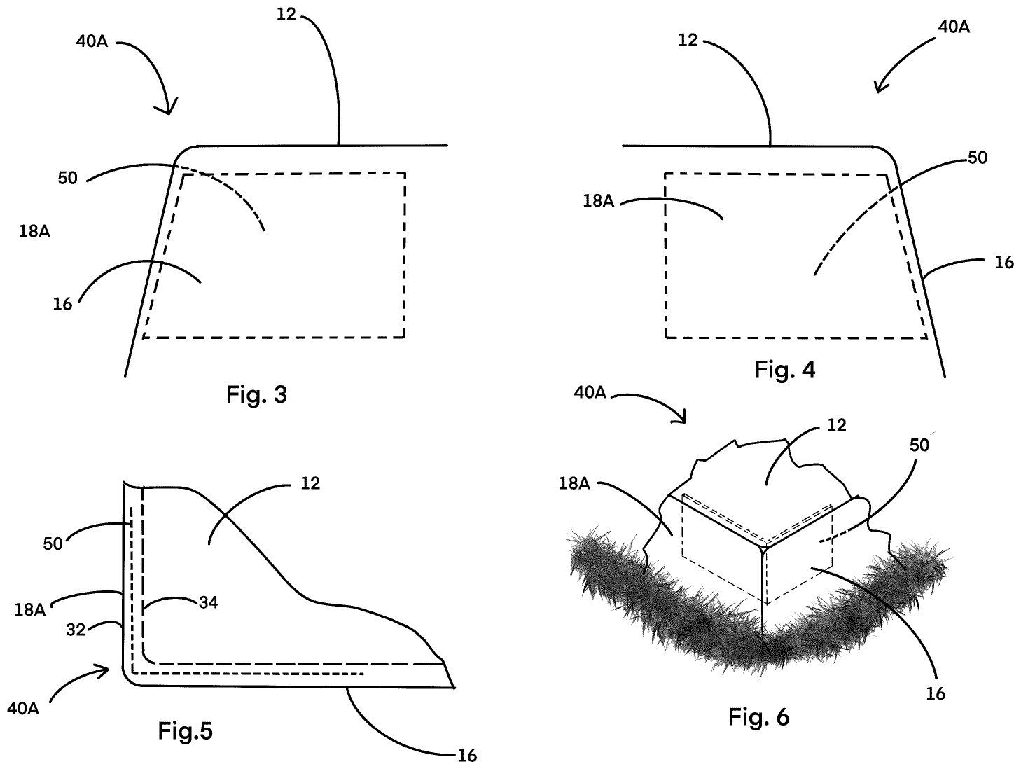

FIGS. 3-6 show a two sided embodiment of a reinforcement 50. The reinforcement 50 is essentially a rectangular length of a sturdy material such as steel or aluminum that has been bent to follow the angle of the corner 40A, 40B, 40C or 40D in which it is embedded. The reinforcement 50 can be seen in the top view of FIG. 5 as residing within the material of the walls of the ground sleeve 10. Because the ground sleeve 10 defines an open space within it, the walls of the ground sleeve 10 have outside surfaces 32 and inside surfaces 34. It can thus be seen that the reinforcement 50 is embedded between the outside surfaces 32 and the inside surfaces 34.

The reinforcement 50, having only two sides, protects the exposed side surfaces of the corners of the ground sleeve 10, which typically encounter the most damage from equipment. When impacted, the fiberglass tends to chip away and the reinforcement 50 ensures that the corners will not be degraded to the point that a hole opens up between the inside and outside of the ground sleeve 10.

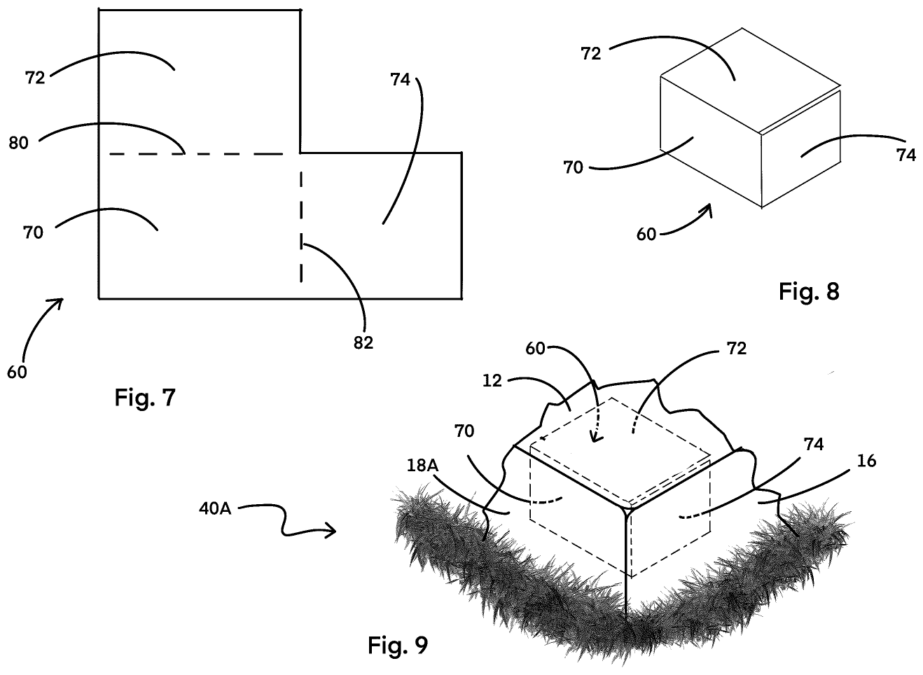

FIGS. 7-9 depict an alternative embodiment of a reinforcement 60. Reinforcement 60 is similar to reinforcement 50 except that it further includes a top surface 72. Looking at FIG. 7, the reinforcement 60 is easily constructed from a flat sheet of material such as aluminum. The “L” shaped material is divided into a front surface 70, a top surface 72, and a side surface 74. These surfaces are separated by fold lines 80 and 82, which are shown as dotted lines. Making approximately 90 degree folds, or folds that match the corner angles of the ground sleeve 10 into which the reinforcement 60 is to be embedded, results in the folded reinforcement 60 shown in FIG. 8.

FIG. 9 shows the reinforcement 60 embedded into the four top corners 40A of a ground sleeve 10. In addition to the left side wall 18A and front wall 16 being protected, the top surface 12 of the four top corners 40A is also protected. This reinforcement 60 embodiment may be advantages in situations where the top surface 12 is relatively low to the ground and thus subject to damage.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A ground sleeve comprising:
a top surface;
four walls including a front wall, a rear wall, a left side wall and a right side wall extending downwardly from the top surface, each wall having an outside surface and an inside surface;
top corners formed at intersections between adjacent walls and the top surface; and,
reinforcements located at each of the top corners;
wherein the top surface and four walls are formed of a plastic;
wherein the reinforcements are formed of a metal; and,
wherein the reinforcements are embedded within the walls during formation of the walls between the outside surface the inside surface.

2. The ground sleeve of claim 1 wherein the plastic is fiberglass.

3. The ground sleeve of claim 1 wherein the metal is aluminum.

4. The ground sleeve of claim 1 wherein the reinforcement is a rectangular length of metal.

5. The ground sleeve of claim 4 wherein the reinforcement is bent to match a shape of the corner in which it is embedded.

6. The ground sleeve of claim 1 wherein the reinforcement is an “L” shaped piece of metal bent to match a shape of the corner in which it is embedded.

7. The ground sleeve of claim 5 wherein the reinforcement is aluminum.

8. The ground sleeve of claim 6 wherein the reinforcement is aluminum.

9. A ground sleeve comprising:
a body shaped to form a hollow box having a top surface and four walls extending downwardly;
corners located at intersections of the walls and the top surface;
metal reinforcements embedded in each of the corners such that the reinforcements are completely encased by a material used to form the body.

10. The ground sleeve of claim 9 wherein the corners comprise four corners.

11. The ground sleeve of claim 9 wherein the material comprises a plastic.

12. The ground sleeve of claim 11 wherein the plastic comprises fiberglass.

13. The ground sleeve of claim 9 wherein the metal reinforcements comprise aluminum.

14. The ground sleeve of claim 9 wherein the reinforcements each comprise two sides.

15. The ground sleeve of claim 9 wherein the reinforcements each comprise three sides.

16. A ground sleeve comprising a box-shaped body of a first material having four top corners, each of the four top corners having reinforcements of a second material embedded within walls of the body.

17. The ground sleeve of claim 16 wherein the first material is fiberglass.

18. The ground sleeve of claim 16 wherein the second material is a metal.

19. The ground sleeve of claim 16 wherein the reinforcements each have two sides.

20. The ground sleeve of claim 16 wherein the reinforcements each have three sides.
